(19) United States
(12) Patent Application Publication
(10) Pub. No.: US 2022/0279868 A1
(43) Pub. Date: Sep. 8, 2022

(54) BREAST TAPE AND METHOD OF APPLYING BREAST TAPE

(71) Applicant: JOJACO.MPP INC., Guelph (DE)

(72) Inventor: Jessica Wylde, Guelph (CA)

(21) Appl. No.: 17/189,343

(22) Filed: Mar. 2, 2021

(51) Int. Cl. A41C 3/06; D04C 1/02; C09J 7/40; C09J 7/21; C09J 7/38

(52) U.S. Cl. CPC A41C 3/065; D04C 1/02; C09J 7/405; C09J 7/21; C09J 7/38; C09J 7/401; D10B 2201/02; D10B 2331/02; D10B 2201/24; D10B 2501/02

(57) ABSTRACT

A breast tape for supporting and lifting breasts and a method of applying the same are provided. The breast tape includes a body of lace, an adhesive applied to one surface of the lace, and a segmented protective material overlaying the adhesive. The breast tape supports and lifts the breasts by molding thereto and is attractive, easy to apply, has a smooth appearance, does not lose adhesiveness with ongoing wear, is breathable, comfortable and does not require heat activation or a lengthy gripping time. The method includes removing a first segment of protective material attached to a base of the breast tape and applying the base to a bottom of the breast, removing a second segment of the protective material, lifting the breast tape to achieve a desired support and lift, and applying the remainder of the breast tape to the skin and molding to the skin.

### TECHNICAL FIELD

The present disclosure relates generally to adhesive tape. More specifically, the present disclosure relates to an adhesive breast tape for supporting and lifting a user's breast, as well as a method of applying the same.

### BACKGROUND

Various devices are available to support and lift human breasts to enhance their appearance. Traditional brassieres are configured with supportive cups, a band surrounding the rib cage, and shoulder straps, but such traditional brassieres are not suitable for backless, strapless, or low-neck garments, as the unsightly straps and the bands of traditional brassieres are visible when worn with these types of garments. A device that is known and has been used with such open-backed garments is adhesive tape. Most adhesive tapes require user cutting and require application to the body in a variety of ways to achieve the desired support and appearance of the human breast; as such, they are difficult to use. As an example, one end of a user-cut adhesive tape strip may be applied to the bottom of the breast, the adhesive tape strip is then pulled until the desired level of support and lift is achieved, and the other end of the adhesive tape strip is secured to the skin. In this way, breast tape can achieve some of the desired lift and support function and can be used with a wide variety of garments; however certain drawbacks still exist.

Although adhesive tapes that are designed to support and lift the breast exist, there are several limitations associated with existing tapes. Known adhesive tapes are packaged as a rectangular tape roll that must be cut into pieces by the user prior to application, which is inconvenient and time consuming. Adhesive tapes that are packaged in this manner are also costlier for users with larger breasts, as these users generally require more tape than those with smaller breasts and must purchase more tape rolls and endure further cutting and self-fitting.

Furthermore, known adhesive tapes require the use of multiple pieces of cut tape in order to achieve desired support and lift, resulting in a bulky appearance and making a smooth molding to the user's breast impossible to achieve, especially for those with large breasts. Adhesive tapes that are packaged as a single roll or multiple rolls of tape are also difficult to remove, as each piece that had to be first cut and applied to the skin must be individually removed. This is a painstaking process as each tape may be painful to remove, especially in this sensitive area.

Additionally, known adhesive tapes wrinkle and cling to themselves once the adhesive backing that normally accompanies the tape is removed and prior to application; this again makes them difficult to apply. This issue is magnified if users must cut and apply, and then again cut and apply multiple pieces of tape before achieving a desired result.

While adhesive tapes with a predetermined, non-rectangular shape exist in the art (e.g. pear-shaped), these tapes focus on protecting the nipple from any discomfort associated with removing the adhesive and are so shaped to circumnavigate the nipple and not to achieve a stronger hold. These tapes function by lifting the breast below the nipple and contain a non-adhesive covered central portion that then covers the nipple. The inclusion of the non-adhesive central portion creates the predetermined shape. However, this non-adhesive portion has drawbacks as it reduces the amount of support and lift available to the breast and therefore is not suitable for those with large breasts as the desired lift and support cannot be achieved. Further, the non-adhesive portion creates an area that is susceptible to bunching as it does not mold to the user's breast in the non-adhesive location. This bunching further creates an undesirable look to the product once applied to the user.

In general, adhesive tapes are also stiff, made from cotton and spandex, and use an acrylic glue as an adhesive. The stiff material is unattractive, uncomfortable and irritates the skin of the user, especially around the nipple. The stiff material also fails to mold well to the user's breast and the outline of the tape may be visible through the user's clothing, creating an undesirable appearance. This stiff material is also difficult to cut without specialized equipment.

Additionally, adhesive tapes employing known glues lose adhesiveness with ongoing wear and peel away from the user's skin after time, losing both lift and shape. This issue is of further concern when users desire to exercise while wearing a known adhesive tape; in such situations user sweat exacerbates the peeling off of the adhesive tape and known tapes are not suitable for such uses.

A further issue with common adhesive tapes is that, upon application, the adhesive used is squeezed and residual glue escapes from in-between the adhesive tape and the user's breast tissue. This escaped glue residue has a tendency to adhere to a user's clothing making removal of the tape difficult and potentially ruining the user's clothing.

As a result, there exists a need for an aesthetically pleasing adhesive breast tape that supports and lifts the breast, is easy to apply, has a smooth appearance as it molds to the user's breast and has no areas that create undesirable bunching, does not lose adhesiveness with ongoing wear or exercise, and does not irritate the skin during use, including around the nipple.

### SUMMARY

In one embodiment, aspects of the present disclosure relate to an adhesive breast tape comprising a breast tape body that is composed of a hollow lace material. The hollow lace material may be composed of about 48% nylon, about 35% rayon, and about 17% cotton. A specialized adhesive coating composed of an acrylic medical grade pressure sensitive adhesive may be applied to a rear surface of the breast tape body, and a protective layer of material may overlay the adhesive coating. A layer of polyurethane film may also be applied between the rear surface of the breast tape body and the adhesive coating to increase the strength of the adhesive breast tape, especially when exposed to water. The additional polyurethane film further prevents sticking of the adhesive coating to a user's clothing as it mitigates glue from escaping off of the breast tape body and coming in contact with clothing. Further, the polyurethane film increases the surface area available for the adhesive coating to bind to and therefore strengthens the hold of the breast tape while maintaining breathability. The polyurethane film improves water resistance and allows the breast tape to maintain its hold of the user's breast despite exposure to water.

The protective layer of material overlaying the adhesive coating may comprise a single plastic single-sided silicone paper that keeps the adhesive from sticking prematurely. The protective layer may be removed prior to use. The protective layer may comprise an upper segment and a separated lower segment.

The adhesive breast tape can be applied by removing the lower segment of the protective layer that covers the base of the breast tape, exposing a lower section of the specialized adhesive coating. The base of the breast tape is then applied to the bottom of the breast at a first location below the nipple and is affixed thereto by the adhesive coating. Once the bottom of the breast is secured, the upper segment of the protective layer that covers the top of the breast tape is removed, thereby exposing an upper section of the adhesive coating. The breast tape can then be lifted to achieve the desired support and lift to the breast. Once the desired lift and support is achieved, the remainder of the breast tape may then be applied and secured to the skin of the user by the upper section of the adhesive coating at a second location above the nipple. The breast tape molds to the user's skin from first location to second location, thereby preventing bunching of the material.

The hollow construction of the lace material, its unique composition that retains strength while providing breathability, the acrylic medical grade pressure sensitive adhesive used that provides a strong adhesion while also not failing during wear and exercise, and the ability of the breast tape to mold across the entirety of the user's breast, each provide benefits over the prior existing adhesive tapes.

### BRIEF DESCRIPTION OF THE DRAWINGS

The following drawings illustrate examples of various components of the present disclosure disclosed herein, and are for illustrative purposes only. Other embodiments that are substantially similar can use other components that have a different appearance.

FIG. 1 illustrates an angled view of the top surface of an embodiment of the present disclosure.

FIG. 2 is a cross-section view of an embodiment of the present disclosure cut at its midpoint.

FIG. 3 illustrates a view of the bottom surface of an embodiment of the present disclosure, including a user peeling back a portion of the embodiment.

### DETAILED DESCRIPTION

A detailed description of the embodiments of the present disclosure will be given in the following disclosure. It will be appreciated that the embodiments provided herein are for illustration only and are not meant to be restrictive. Other embodiments of the present disclosure will readily suggest themselves to skilled persons having the benefit of this disclosure.

The breast tape disclosed herein relates to an adhesive tape that can be used to support and lift human breasts without the drawbacks of existing adhesive tapes or traditional brassieres.

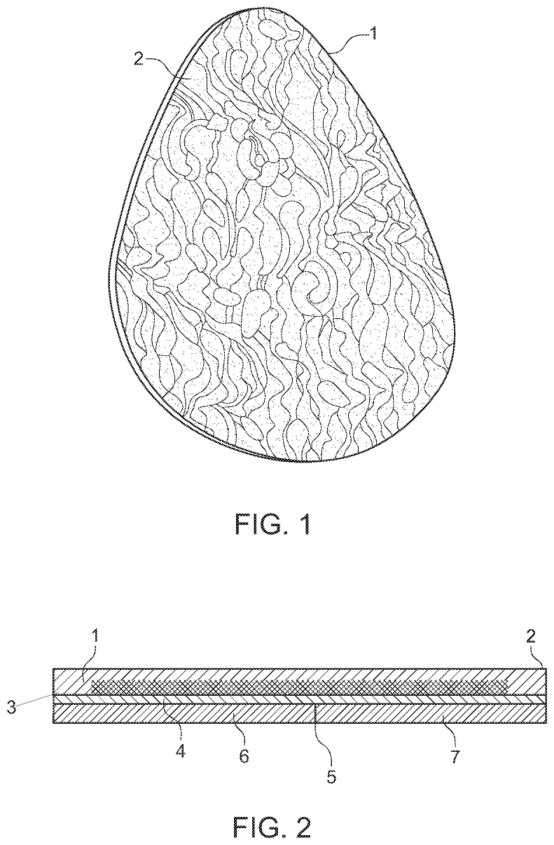

FIG. 1 and FIG. 2 illustrate an embodiment of the present disclosure. As can be seen, provided is a breast tape that comprises a breast tape body 1 with a top surface 2 and a rear surface 3. The breast tape body 1 may be made of a lace material comprising hollow portions or empty (of material) cavities. The lace material may be composed of nylon, rayon and cotton. In a non-limiting example, the composition is substantially in the range of about 48% nylon, about 35% rayon, and about 17% cotton. This example composition of lace may be desirable for a breast tape as it supports a variety of breast sizes, binds well to adhesives, can be easily cut, and molds seamlessly to the breast. Due to the strength and elasticity of the example composition of the lace material, the breast tape may be suitable and may provide support for a variety of breast shapes and sizes without tearing, while also providing a suitable strength to support those with larger breasts. In some examples, the lace composition may also be flexible and may not be a stiff material that is unattractive and uncomfortable so as to irritate the skin. Flexible material also provides the benefit of molding well to the human breast and so the outline of the breast tape is not visible through the user's clothing, and an undesirable appearance is avoided.

The breast tape body 1 may have any predetermined shape, which allows the breast tape to be manufactured on scale in a variety of sizes following the predetermined shape. In one example embodiment, the breast tape body 1 may be generally pear- or tear-shaped (as can be seen in FIG. 1), but, in general, may be made into any shape that best accomplishes the goals of supporting and lifting the breasts and molding to them. In a non-limiting example, a height of the breast tape body 1 is about 22.3 centimeters and a width of the breast tape body 1 is about 15.3 centimeters at its widest point, which coincides with a standard size “large”. The example pear-shape of the breast tape body 1 limits the need for a user to cut the breast tape and thereby allows for an easier application and removal as its shape matches that of the breast—a single peel-away of the breast tape is used rather than piece by piece. However, owing to the composition of material used, the user may still easily cut the breast tape body 1 prior to it being employed if so needed. Ease of cutting and forming allows the breast tape body 1 to more easily mold to the user and prevents bunching and ill-fits.

The top surface 2 of the breast tape body 1 faces away from the human breast tissue and is free from adhesive. The rear surface 3 of the breast tape body 1 faces towards, and is meant to be applied to, human breast tissue. The rear surface 3 includes an adhesive coating 4. In some examples, the adhesive coating 4 may include an acrylic medical grade pressure sensitive adhesive that may be applied by any known coating machine to the rear surface 3 of the breast tape body 1. The acrylic medical grade pressure sensitive adhesive may be applied to the entire surface of the rear surface 3 and thereby creates maximum attachment to the user's breast tissue as no part of the rear surface is adhesive-free.

In a non-limiting example, the adhesive coating 4 may include a hydrocolloid hotmelt pressure sensitive adhesive (PSA). This type of adhesive is well-suited for applications including, for example, advanced wound dressings, acne treatment, and ostomy care, where the application may include continued contact with human skin. The ability to maintain contact with human skin without irritation makes the adhesive also well-suited for the breast tape of the present disclosure. Further, this type of adhesive coating does not include any waiting time to set and grip, nor does it include heat activation to achieve a desired hold. The adhesive coating 4 may be formed such that it does not lose its adhesive strength during normal wear and further does not lose its adhesive strength when exposed to a user's sweat, for example, when a user is exercising.

The hydrocolloid formulation delivers an outstanding balance of adhesion and peel strength, and further delivers excellent moisture retention, good breathability and enhanced wearing comfort. The hydrocolloid formulation for the adhesive coating 4 may be supplied, for example, by Henkel AG & Co. KGaA, a German chemical and consumer goods company.

The body 1 of the breast tape desirably includes sufficient surface area for the adhesive coating 4 to bind to in order to support the breast; however, it may also be desirable for the body 1 of the breast tape to be breathable for the user. A lace composition that is hollow as mentioned above may be desirable in order to maintain enough surface area while also maintaining structural integrity. In some examples, a structural integrity may be maintained by using a composition of substantially about 48% nylon, about 35% rayon, and about 17% cotton. In some examples a high surface area may be achieved by using hollow lace with patterns in the lace to which the adhesive may to bind to. In one embodiment, the hollow lace may contain a floral-styled pattern. Due to the flexible composition of the hollow lace and the adhesive coating 4, the breast tape of the present disclosure offers increased breathability and comfort to the wearer.

A protective layer 5 may be affixed over the rear surface 3 and directly atop the adhesive coating 4 to cover the adhesive coating 4 and prevent it from sticking prematurely, and prior to use. The protective layer 5 may be composed of an upper segment 6 and a lower segment 7 with a cut line to separate the sections, allowing a user to peel one section at a time while leaving the other section in place to maintain protection of the underlying adhesive.

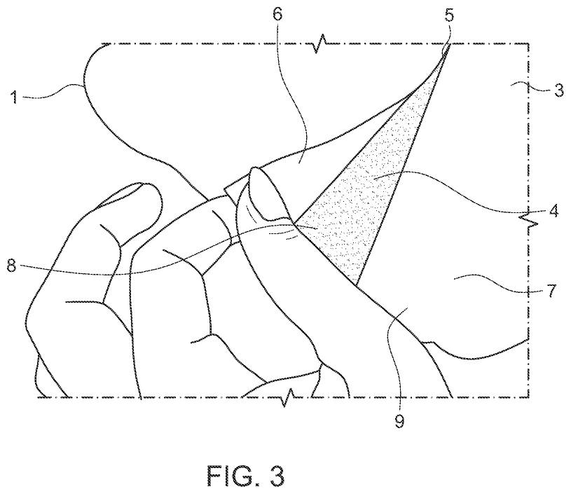

FIG. 3 illustrates the rear surface 3 of the breast tape body 1, including the adhesive coating 4 and the protective layer 5 that covers the adhesive coating 4. As noted above, the protective layer 5 may further comprise an upper segment 6 and a lower segment 7. The upper segment 6 of the protective layer 5 covers an upper portion 8 of the rear surface 3 and the lower segment 7 of the protective layer covers a lower portion 9 (shown underneath lower segment 7 in FIG. 3) of the rear surface 3 of the breast tape body 1.

In a non-limiting example, a height of the lower segment 7 of the protective layer 5 is about 5 inches and a height of the upper segment 6 of the protective layer 5 is about 4.5 inches. In one embodiment, the protective layer 5 may comprise a single plastic single-sided silicone paper.

In some examples, a layer of polyurethane film (not shown in the figures) may be applied using any known coating machine onto the rear surface 3 of the breast tape body. The adhesive coating 4 is then applied onto the layer of polyurethane film instead of directly onto the rear surface 3. The polyurethane film may increase the surface area available for the adhesive coating to bind to as it fills the spaces created by the cavities of the hollow lace material. Increasing the available surface area strengthens the hold of the breast tape to the user's body. Breathability is maintained as the polyurethane film is perforated, thereby maintaining multiple closely packed holes, which allow for the flow of air.

The polyurethane film may further improve water resistance and may allow the breast tape to maintain its hold of the user's breast despite exposure to water or to the user's sweat.

An example method of applying a breast tape of the present disclosure is now described.

First, the user may ensure that their skin is clean and dry, free from powders, oils and lotions. Next, the user may wish to apply any nipple covering to protect the nipple and areola as the full rear surface 3 of the breast tape body 1 is covered with an acrylic medical grade pressure sensitive adhesive. However, this nipple covering is not strictly necessary and need not be used as the adhesive itself is sensitive and should not irritate the nipple during use. Next, the lower segment 7 of the protective layer 5 may be removed, exposing the adhesive coating 4 of the lower portion 9 of the rear surface 3 of the breast tape body 1. The now exposed lower portion 9 of the rear surface 3 of the breast tape body 1 may now be applied and secured to the user's clean and dry skin at the bottom of the user's breast. Next, the upper segment 6 of the protective layer 5 may be removed exposing the adhesive coating 4 of the upper portion 8 of the rear surface 3 of the breast tape body 1. The breast tape body 1 may now be stretched and lifted and, as it is lifted, the breast tissue to which it has been applied is also lifted and the support and lift desired by the user may be achieved. The exposed upper portion 8 of the rear surface 3 of the breast tape body 1 may now be applied and secured to the user's skin above the breast as desired. The breast tape body 1 then molds to the breast from the first location to the second location.

While embodiments and applications of the present disclosure have been shown and described herein, it will be apparent to those skilled in the art having the benefit of the present disclosure that numerous modifications, variations and other embodiments other than those mentioned above are possible without departing from the scope of the present disclosure.

1. A breast tape for lifting and supporting a breast of a user comprising:
a breast tape body comprising a lace material;
the breast tape body having a front surface and a rear surface;
the rear surface having an upper rear portion and a lower rear portion;
an adhesive coating applied to substantially a whole of the rear surface, including both the upper rear portion and the lower rear portion;
the adhesive coating applied to the lower rear portion adapted to adhere to breast tissue of the user at a first location below a nipple of the user, the adhesive coating applied to the upper rear portion being adapted to adhere to the user's breast tissue at a second location above the user's nipple, and the breast tape body adapted to attach and mold to the breast tissue between the first location and second location,
wherein adherence of the breast tape body to the user provides lift and support to the user's breast; and,
a peel-away removable protective layer applied substantially over the whole of the adhesive coating to maintain an adhesiveness of the adhesive coating while the protective layer remains in place.

2. The breast tape of claim 1 wherein the lace material comprises a composition of nylon, rayon and cotton.

3. The breast tape of claim 2 wherein the composition comprises substantially about 48% nylon, about 35% rayon and about 17% cotton.

4. The breast tape of claim 1 wherein the adhesive coating comprises an acrylic medical grade pressure sensitive adhesive.

5. The breast tape of claim 4 wherein the acrylic medical grade pressure sensitive adhesive includes a hydrocolloid hotmelt pressure sensitive adhesive (PSA).

6. The breast tape of claim 1 wherein the protective layer comprises a single plastic single-sided silicone paper.

7. The breast tape of claim 6 wherein the protective layer comprises a separate peel-away upper segment and peel-away lower segment, wherein the upper segment overlays at least the upper rear portion and the lower segment overlays at least the lower rear portion and each segment is adapted to be peeled-away individually.

8. The breast tape of claim 1 wherein the breast tape body has a pear-shape.

9. The breast tape of claim 1 further comprising a perforated polyurethane film that is applied to the rear surface between the rear surface and the adhesive coating.

10. A method of applying a breast tape for lifting and supporting a breast of a user comprising the steps of:
removing a protective layer overlaying an adhesive coating substantially applied to a whole of a rear surface of a breast tape body thereby exposing an adhesive of the adhesive coating,
wherein the breast tape body comprises a lace material;
attaching the exposed adhesive on a lower portion of the rear surface of the breast tape body to a first location below the nipple of the user;
lifting the breast tape body to lift and support the user's breast;
attaching the exposed adhesive on an upper portion of the rear surface of the breast tape body to a second location above the user's nipple; and
ensuring that substantially an entire rear surface of the breast tape body is adhesively attached and thereby molds to a skin of the user between the first location and the second location.

11. The method as set forth in claim 10, wherein the protective layer comprises a separate lower segment and upper segment, wherein the lower segment is adapted to be removed prior to attaching the breast tape to the first location and the upper segment is adapted to be separately removed prior to attaching the breast tape to the second location.
